(19) United States
(12) Patent Application Publication
(10) Pub. No.: US 2006/0285073 A1
(43) Pub. Date: Dec. 21, 2006

(54) Pair of glasses

(76) Inventor: Hsien-Jung Yeh, Tainan City (TW)

Correspondence Address: Hsien-Jung Yeh, P.O. Box 90, Tainan City, 70499, TW

(21) Appl. No.: 11/156,639

(22) Filed: Jun. 21, 2005

(51) Int. Cl. G02C 7/10

(52) U.S. Cl. 351/164

(57) ABSTRACT

A pair of glasses includes a main body having a frame surrounding two separate areas. Each area is divided into a sunglass section and a presbyopia section. Each sunglass section is located at the upper part each area for a larger portion and to be filled with a sunlight glass. Each presbyopia section is located at the inner and lower part of frame for a smaller portion and to be filled with a farsighted lens.

### BACKGROUND OF THE INVENTION

1. Field of the Invention

This invention relates to a pair of glasses, particularly one that possesses two separate areas able to be used as both sunglasses and farsighted lenses.

2. Description of the Prior Art

Usually, as people do outdoors activities, colored sunglasses are often worn to keep eyes from being attacked by the strong sunlight. But, conventional sunglasses are not suitably made for presbyopia correction because their colored lenses are too dark to provide enough brightness for seeing clearly small objects near by. Therefore, it's always necessary to carry two pairs of glasses for alternative usage for those who, suffering with presbyopia, have to contact with the sunlight often. The present invention is aimed to avoid such an annoying situation.

### SUMMARY OF THE INVENTION

The prime object of this invention is to offer multi-functional glasses.

The main characteristics of the invention are a main body provided with a frame surrounding two separate areas. Each area is divided into a sunglass region and a presbyopia region. Each sunglass region is located at the upper part of each area for a larger portion and to be filled with a sunlight glass. Each presbyopia region is located at the inner and lower part of each area for a smaller portion and to be filled with a farsighted lens.

### BRIEF DESCRIPTION OF DRAWINGS

This invention is better understood by referring to the accompanying drawings, wherein:

FIG. 1 is a perspective view of glasses in the present invention.

### DETAILED DESCRIPTION OF THE PREFERRED EMBODIMENT

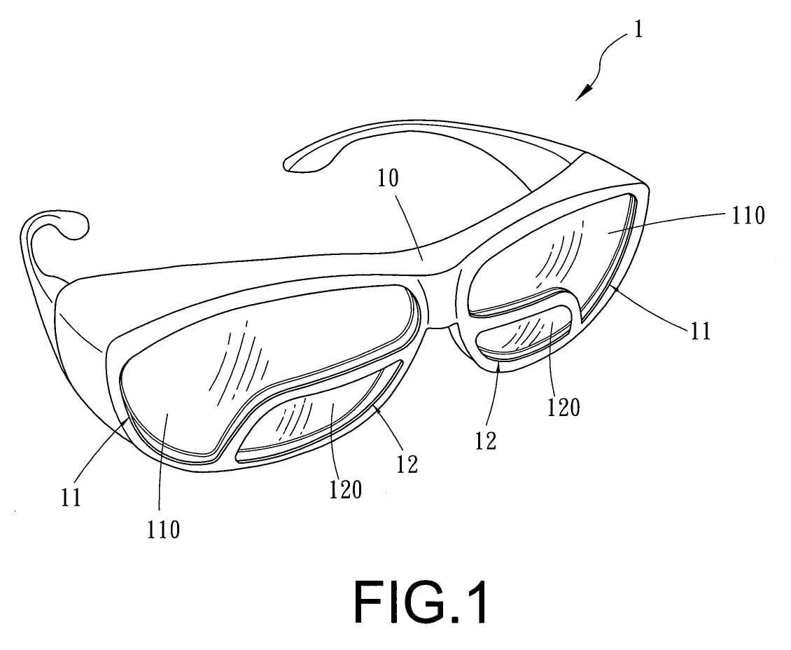

A preferred embodiment of a pair of glasses in the present invention, as shown in FIG. 1, includes mainly a main body 1, which is provided with a frame 10 surrounding two separate areas respectively divided into two sections, a sunglass section 11 and a presbyopia section 12. The sunglass section 11 is located at the upper part of each area with a larger portion and to be filled with a sunlight glass 110. The presbyopia section 12 is located at the inner and lower part of each area 10 with a smaller portion and to be filled with a farsighted lens 120.

When one wears the pair of glasses of the present invention, he can use the sunlight glasses 110 in the two sunglass sections 11 as sunglasses for protecting eyes and use the farsighted lenses 120 in the presbyopia sections 12 to read or see objects near by, without need of preparing two pairs of glasses.

While the preferred embodiment of the invention has been described above, it will be recognized and understood that various modifications may be made therein and the appended claims are intended to cover all such modifications that may fall within the spirit and scope of the invention.

1. A pair of glasses comprising:
A main body having a frame, said frame surrounding two separate areas, each said area divided into a sunglass section and a presbyopia section, each said sunglass section located at an upper part and lower outer part of each said area for a larger portion, and each said presbyopia section having an approximate rectangular shape and being distributed at a lower inner part of said area, each said sunglass section filled with a sunlight glass, each said presbyopia section filled with a farsighted lens.
